(19) United States
(12) Patent Application Publication
(10) Pub. No.: US 2007/0160252 A1
(43) Pub. Date: Jul. 12, 2007

(54) Earphone storage structure

(75) Inventors: John C. Wang, Taoyuan City (TW); Yi-Shen Wang, Taoyuan City (TW)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HIGH TECH COMPUTER CORP., Taoyuan City (TW)

(21) Appl. No.: 11/523,456

(22) Filed: Sep. 19, 2006

(30) Foreign Application Priority Data
Jan. 11, 2006 (TW) 95101085

(51) Int. Cl. H04R 25/00

(52) U.S. Cl. 381/378; 381/370

(57) ABSTRACT

The present invention provides an earphone storage structure comprising a necklace, two fasteners formed in the two ends of the necklace respectively and a stopper formed in the necklace. The size of the fasteners is less than the size of the stopper and the size of the earphones. Therefore, the earphone may couple with the necklace with the fasteners fastening the earphones. Moreover, the stopper and the fasteners may together determine the extendable distance of the earphones.

### RELATED APPLICATIONS

The present application is based on, and claims priority from, Taiwan Application Serial Number 95101085, filed Jan. 11, 2006, the disclosure of which is hereby incorporated by reference herein in its entirety.

### FIELD OF THE INVENTION

The present invention is about a storage structure, and more particularly, is about a structure for storing earphone.

### BACKGROUND OF THE INVENTION

Listening to the music is a common leisure time activity. Earphones are used to listen to music to avoid disturbing others. However, when earphones are not being used, it is difficult to store them. Because of the long earphone wire, the wire is always wound together when the earphone is directly placed into a bag for storage.

Typically, a storage box with a winding reel is used to store earphones. The winding reel is used to wind the earphone's wire into the store box to prevent the earphone wire from getting tangled up. However, if such a storage method is used, a user must take an additional storage box to store the earphones in. It is still not very convenient for users because the earphones must initially be removed from the box before they can be used. This is especially inconvenient, when the earphones are urgently needed.

Therefore, an earphone storage structure that can avoid the foregoing problems is required.

### SUMMARY OF THE INVENTION

Therefore, the main purpose of the present invention is to provide an earphone storage structure that may prevent the earphone's wire from getting tangled up.

Accordingly, the present invention provides an earphone storage structure comprising a necklace, two fasteners formed in the two ends of the necklace respectively and a stopper formed in the necklace. The size of the fasteners is less than the size of the stopper and the size of the earphones. Therefore, fasteners may couple the earphone with the necklace. Moreover, the stopper and the fasteners may together determine the extendable distance of the earphones.

According to an embodiment, the earphone storage structure further comprises a switch formed in the stopper. The switch is switched when the fastener fastens with the stopper.

According to an embodiment, the earphone storage structure further comprises a switch formed in the fastener.

In another embodiment, the present invention provides an earphone storage structure comprising a fastener and a stopper formed in the earphone's wire. The size of the fastener is less than the size of the stopper and the size of the earphone. The stopper and the fastener may together determine the extendable distance of the earphone. In an embodiment, the two earphones are extended from the fastener in the same direction and are located on the same side of the fastener. In another embodiment, the two earphones are extended from the fastener in the opposite direction and are located on different sides of the fastener.

According to an embodiment, the earphone storage structure further comprises a switch formed in the stopper. The switch is switched when the fastener fastens with the stopper.

According to an embodiment, the earphone storage structure further comprises a switch formed in the fastener.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1A to FIG. 1E illustrate schematic diagrams of the earphone storage structure according to the first embodiment of the present invention;

FIG. 2A to FIG. 2C illustrate schematic diagrams of the earphone storage structure according to the second embodiment of the present invention;

FIG. 3A to FIG. 3B illustrate schematic diagrams of the earphone storage structure according to the third embodiment of the present invention; and

FIG. 4A to FIG. 4B illustrate schematic diagrams of the earphone storage structure according to the fourth embodiment of the present invention.

### DETAILED DESCRIPTION OF THE PREFERRED EMBODIMENT

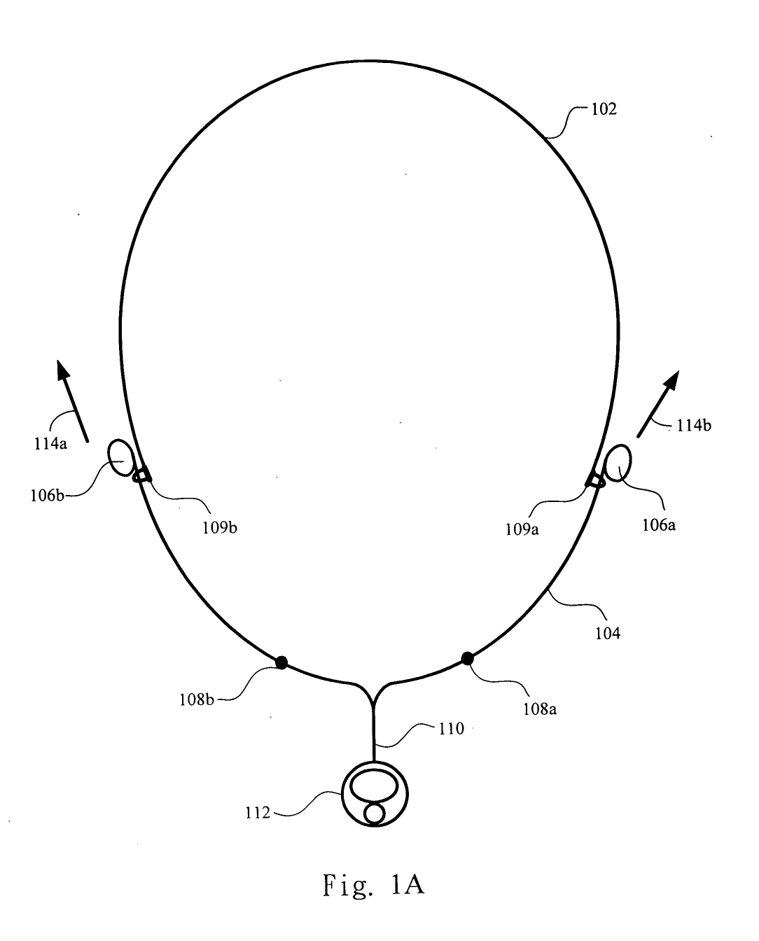

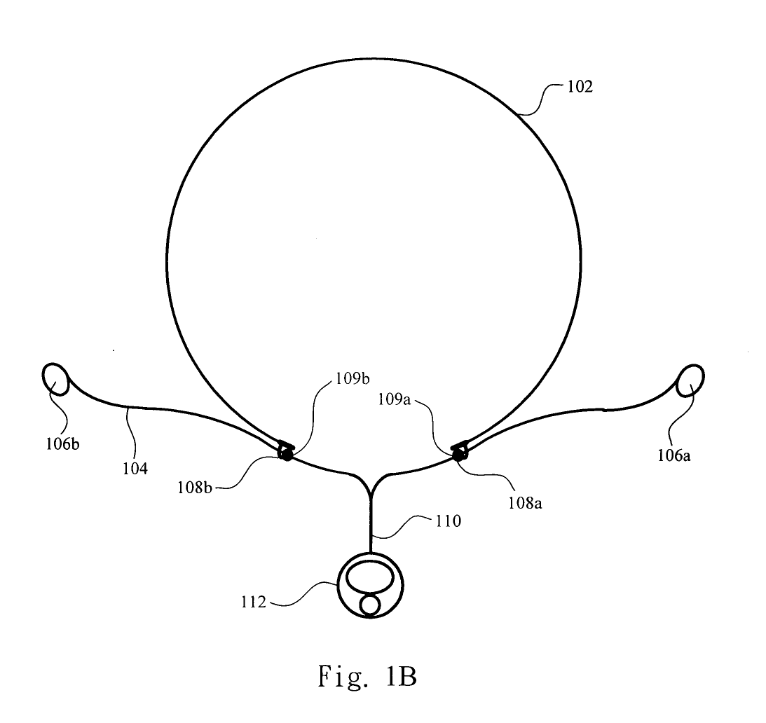

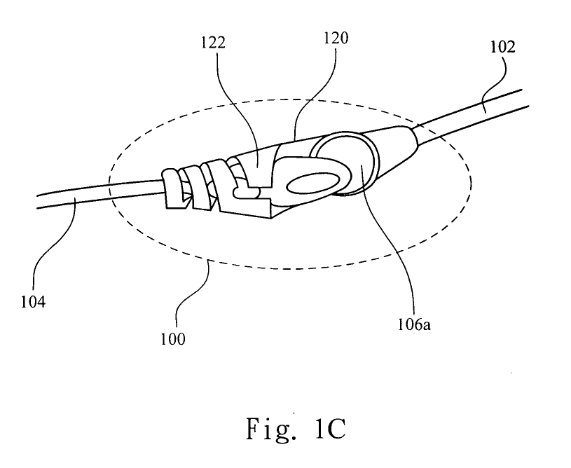

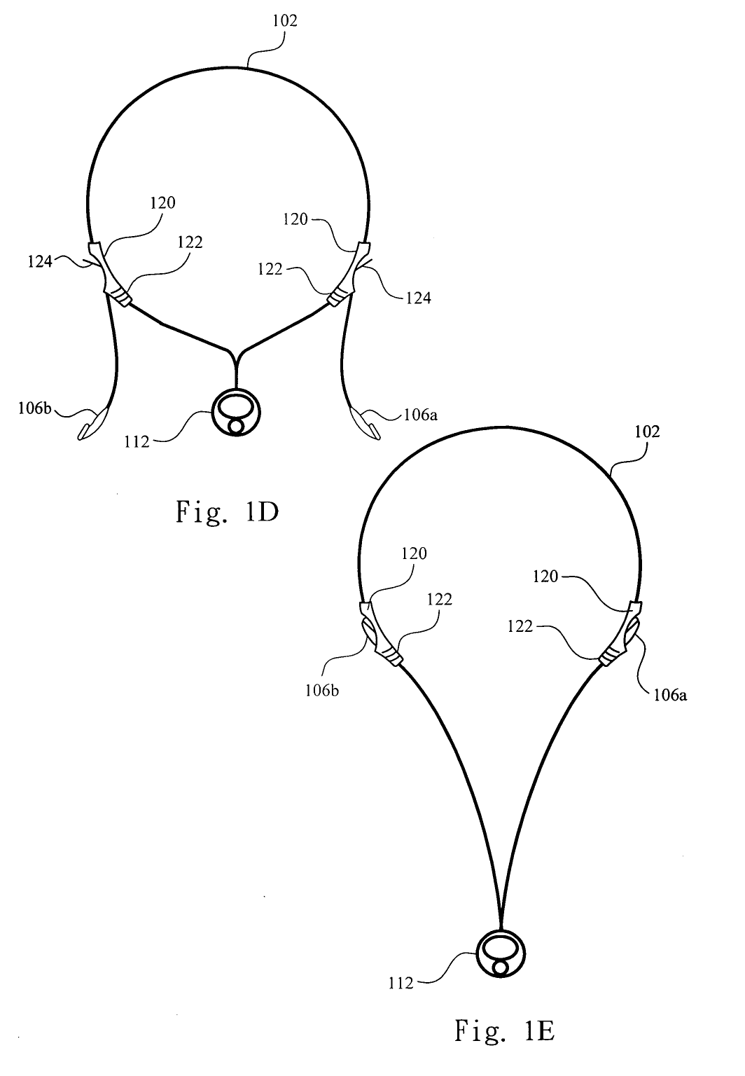

1. FIG. 1A illustrates a schematic diagram of the earphone storage structure according to the first embodiment of the present invention. The earphone storage structure comprises a necklace 102 and earphones 106a and 106b connected together by a wire 104. Two rings 109a and 109b are formed in the two ends of the necklace 102 respectively. Two stoppers 108a and 108b are formed on the wire 104. The size of stoppers 108a and 108b are large than the size of the rings 109a and 109b. The wire 104 passes through the two rings 109a and 109b. The stopper 108a and the ring 109a together determine the extendable distance of the earphone 106a. The stopper 108b and the ring 109b together determine the extendable distance of the earphone 106b. A connector 110 of the wire 104 is formed in the location between the two stoppers 108a and 108b to connect with a hand-held device 112, such as a cell phone, a PDA or a walkman. In an embodiment, the structure of the stopper 108a and 108b is similar to a bump.

When a hand-held device 112 is connected to the earphone storage structure, this hand-held device 112 may be hung on the neck of a user with the necklace 102. When the earphones 106a and 106b are not used, the hand-held device 112 can be hung on the neck as a pendant by the rings 109a and 109b catching the earphones 106a and 106b respectively. When using the earphones 106a and 106b, a user may pull out the earphones 106a and 106b following the direction indicated by the arrow 114a and 114b in FIG. 1A. In an embodiment, switches are formed in the stoppers 108a and 108b respectively. These switches are switched by the touching of the stoppers 108a and 108b and the rings 109a and 109b. In another embodiment, a switch is only formed in one of the two stoppers 108a or 108b. Moreover, in another embodiment, switches are formed in the rings 109a and 109b respectively. Similarly, in another embodiment, a switch is only formed in one of the two rings 109a or 109b.

It is noticed that, in these embodiments, the connection of the necklace 102 and the wire 104 passes through the catching rings 109a and 109b and the earphones 106a and 106b respectively. However, in another embodiment, as shown in the FIG. 1C, a designed fastener 100 can be used to replace the ring. This fastener 100 includes a base 120 connected with the necklace 102. A ring 122 whose size is less than the size of earphone 106a is formed in the base 120. When the earphone 106a is not used, this earphone 106a may be stored in the base 120 to protect itself. In an embodiment, a special location is set in the base 120 for storing the earphone 106a to make the face of the earphone 106a always toward the base 120 when the earphone 106a is stored in the special location.

In another embodiment, as shown in the FIG. 1D, a switch 124 is formed in the base 120 to control the hand-held device 112. When the earphone 106a or/and earphone 106b are used, the switch 124 starts the hand-held device 112 once the earphone leaves the base 120. On the other hand, as shown in the FIG. 1E, when the earphones are located in the base 120, the earphone 106a or/and earphone 106b touches the switch 124 to stop the hand-held device 112. In another embodiment, if the hand-held device 112 is a cell phone, an additional microphone (not shown in this figure) can be installed on the wire 104. A user can use this microphone to answer a call.

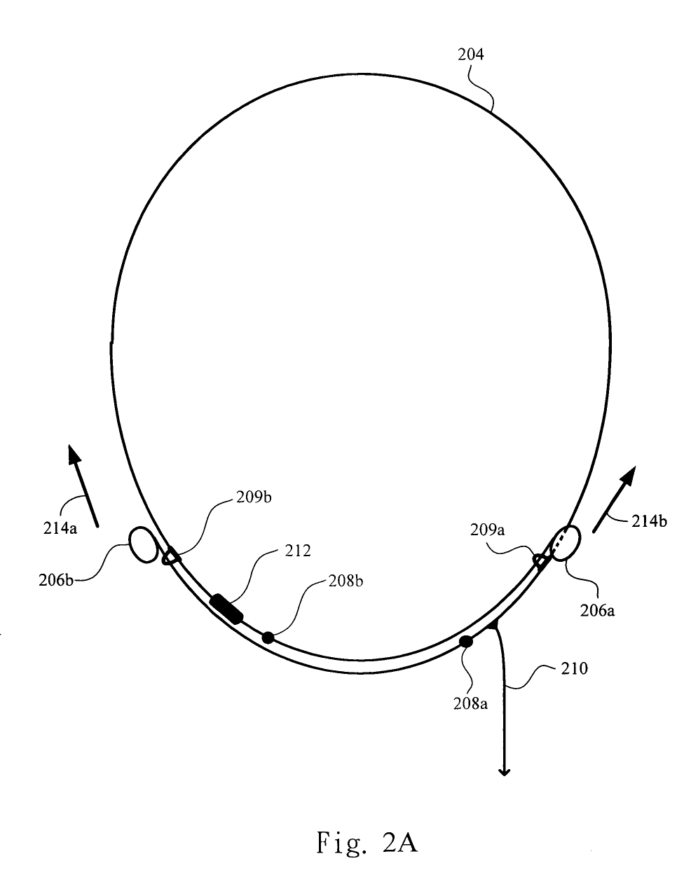

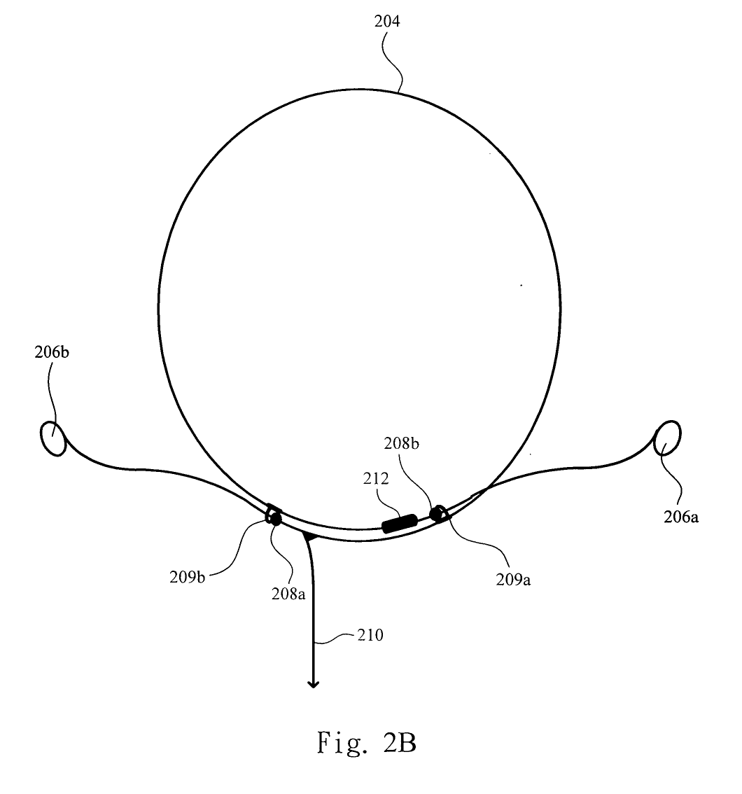

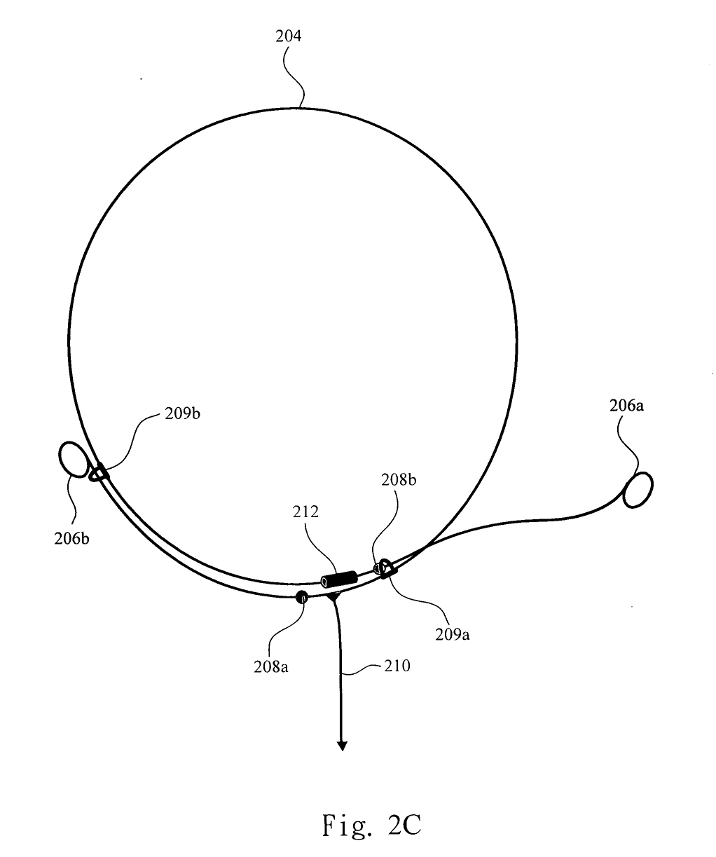

FIG. 2A illustrates a schematic diagram of the earphone storage structure according to the second embodiment of the present invention. The earphone storage structure comprises an earphone's wire 204 and two earphones 206a and 206b connected together by this wire 204. Two rings 209a and 209b are formed in the two ends of the wire 204 respectively. The size of the rings 209a and 209b is less than the size of the earphones 206a and 206b. A stopper 208a whose size is larger than the size of the ring 209b is formed in the location between the earphone 206b and the ring 209a in the wire 204. The stopper 208a is used to limit the extendable distance of the earphones 206b. A stopper 208b whose size is larger than the size of the ring 209a is formed in the location between the earphone 206a and the ring 209b in the wire 204. The stopper 208b is used to limit the extendable distance of the earphones 206a. In an embodiment, the structure of the stopper 208a and 208b is similar to a bump.

In other words, according to this embodiment, the earphone 206a, the stopper 208b and the ring 209b are sequentially formed in one end of the wire 204. The earphone 206b, the stopper 208a and the ring 209a are sequentially formed in another end of the wire 204. The earphone 206b passes through the ring 209b. The earphone 206a passes through the ring 209a. According to this embodiment, the connector 210 is formed in the location between the stopper 208a and the ring 209a. The microphone 212 is formed in the location between the stopper 208b and the ring 209b. In another embodiment, the connector 210 and the microphone 212 may also be formed in other locations.

A user may hang the wire 204 on his/her neck to use the earphones. Moreover, as shown in the FIG. 2A, the rings 209a and 209b may catch the earphones 206a and 206b respectively. A part of the wire 204 may overlap together in such a structure to reduce the length of the wire 204 and prevent the wire 204 from getting tangled. When using the earphones 206a and 206b, a user may pull out the earphones 206a and 206b in the direction indicated by the arrows 214a and 214b in the FIG. 2B. The stopper 208b and the ring 209a together determine the extendable distance of the earphone 206a. The stopper 208a and the ring 209b together determine the extendable distance of the earphone 206b. On the other hand, as shown in the FIG. 2C, a user may only pull out one of the earphones 206a and 206b.

It is noticed that the fastener structure 100 described in the first embodiment may also be used in the second embodiment. In an embodiment, switches are formed in the stoppers 208a and 208b respectively. These switches are switched by touching of the stoppers 208a and 208b and the rings 209a and 209b. In another embodiment, a switch is only formed in one of the two stoppers 208a and 208b. Moreover, in another embodiment, switches are formed in the rings 209a and 209b respectively. Similarly, in another embodiment switch is only formed in one of the two rings 209a and 209b.

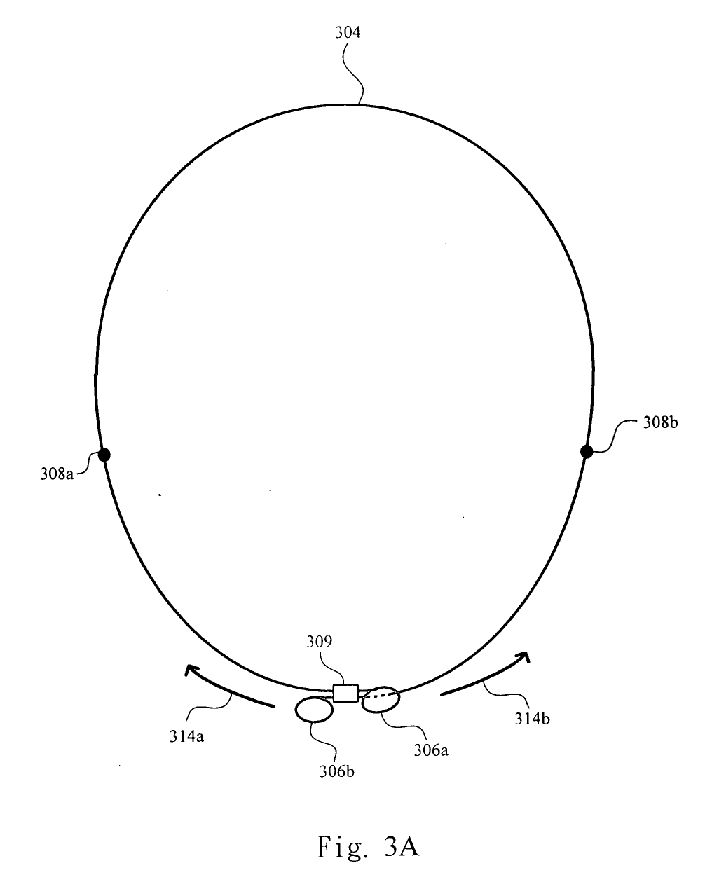

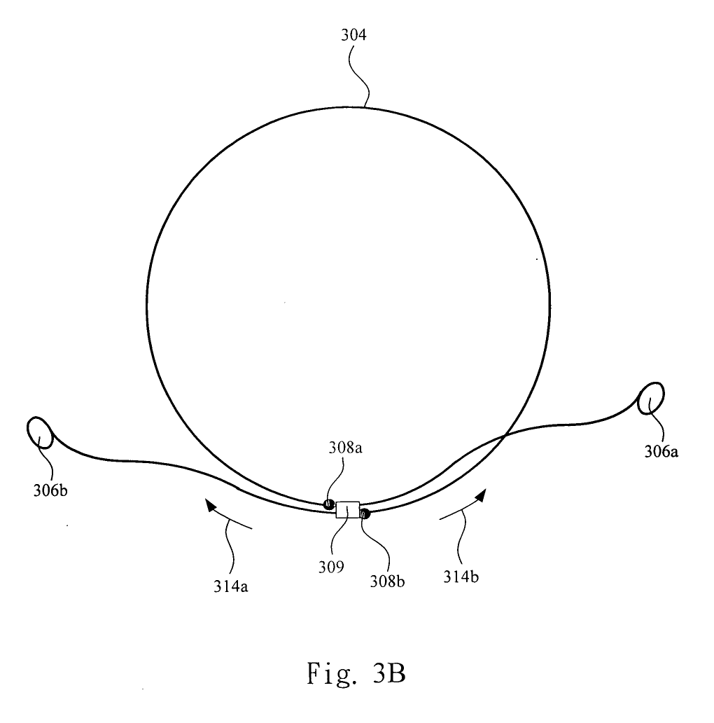

FIG. 3A illustrates a schematic diagram of the earphone storage structure according to the third embodiment of the present invention. The earphone storage structure comprises an earphone's wire 304 and earphones 306a and 306b connected together by this wire 304. A ring 309 is formed in the wire 304. The size of ring 309 is less than the size of the earphones 306a and 306b. The earphones 306a and 306b are located in the two sides of the ring 309 respectively. Therefore, there is an overlap of the wire 304 in the ring 309. A stopper 308a whose size is larger than the size of the ring 309 is formed in the location away from the earphone 306a in the wire 304. The stopper 308a is used to limit the extendable distance of the earphones 306a. On the other hand, a stopper 308b whose size is larger than the size of the ring 309 is formed in the location away from the earphone 306b in the wire 304. The stopper 308b is used to limit the extendable distance of the earphones 306b. In an embodiment, the structure of the stopper 308a and 308b is similar to a bump

A user may hang the wire 304 on the neck to use the earphones. Moreover, as shown in the FIG. 3A, the ring 309 may catch the earphones 306a and 306b respectively to prevent the wire 304 from getting tangled. When using the earphones 306a and 306b, a user may pull out the earphones 306a and 306b in the direction indicated by the arrows 314a and 314b in the FIG. 3B. The stopper 308a and the ring 309 together determine the extendable distance of the earphone 306a. The stopper 308 and the ring 309 together determine the extendable distance of the earphone 306b.

It is seen that the fastener 100 structure described in the first embodiment may also be used in the third embodiment. In an embodiment, switches are formed in the stoppers 308a and 308b respectively. These switches are switched by the touching of the stoppers 308a and 308b and the ring 309. In another embodiment, the switch is only formed in one of the two stoppers 308a or 308b. Moreover, in another embodiment, the switch is formed in the ring 309.

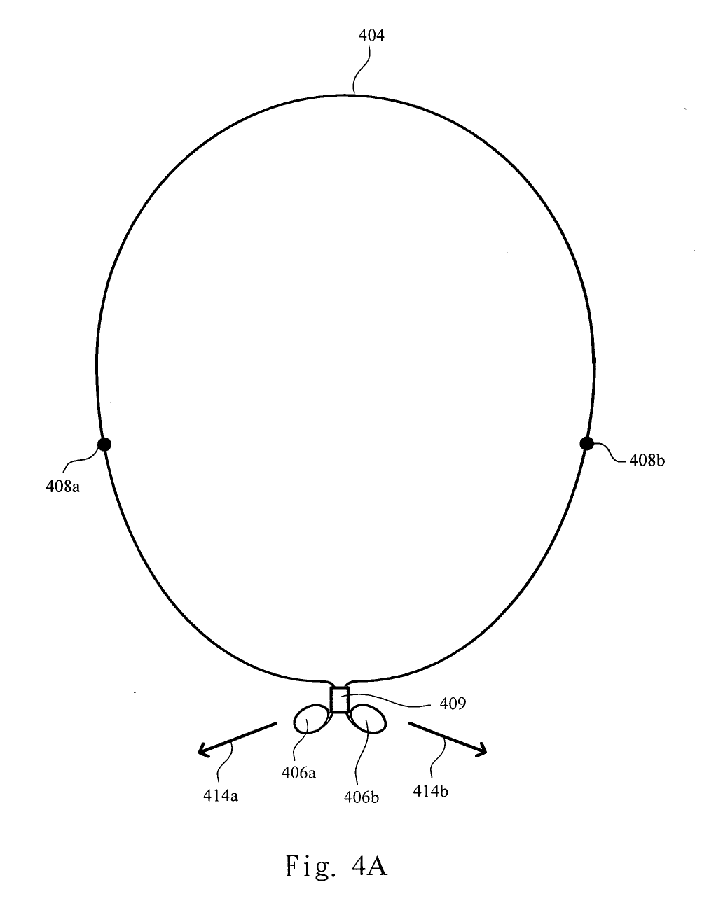

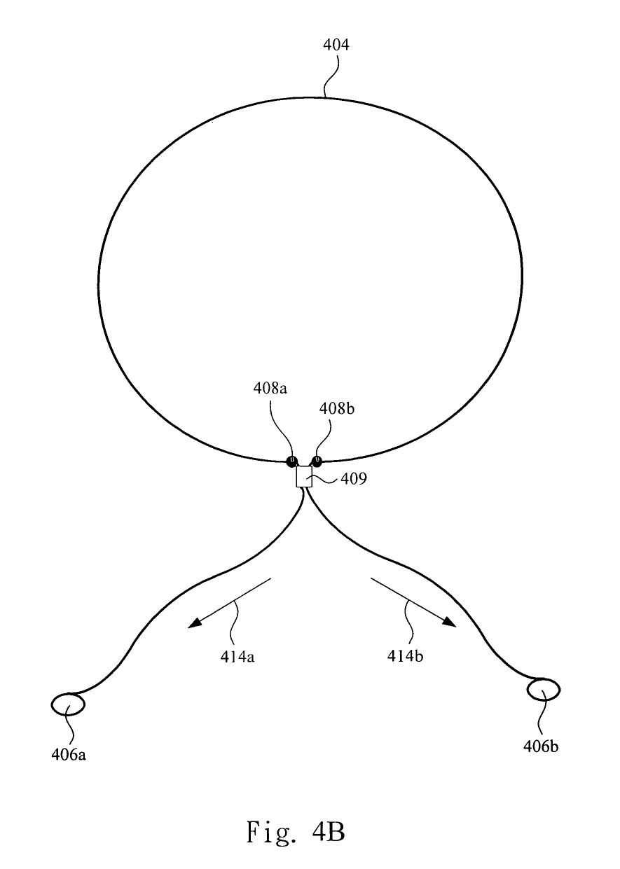

FIG. 4A illustrates a schematic diagram of the earphone storage structure according to the fourth embodiment of the present invention. The earphone storage structure comprises an earphone's wire 404 and earphones 406a and 406b connected together by this wire 404. A ring 409 is formed in the wire 404. The size of ring 409 is less than the size of the earphones 406a and 406b. The main difference between the third embodiment and the fourth embodiment is that the earphones 406a and 406b are located on the same side of the ring 409. A stopper 408a whose size is larger than the size of the ring 409 is formed in a location away from the earphone 406a in the wire 404. The stopper 408a is used to limit the extendable distance of the earphones 406a. On the other hand, a stopper 408b whose size is larger than the size of the ring 409 is formed in a location away from the earphone 406b in the wire 404. The stopper 408b is used to limit the extendable distance of the earphones 406b. In an embodiment, the structure of the stopper 408a and 408b is similar to a bump

A user may hang the wire 404 on his/her neck to use the earphones. Moreover, as shown in the FIG. 4A, the ring 409 may catch the earphones 406a and 406b respectively to avoid the wire 404 from getting tangled. When using the earphones 406a and 406b, a user may pull out the earphones 406a and 406b in the direction indicated by the arrows 414a and 414b in the FIG. 4B. It is noticed that the fastener structure 100 described in the first embodiment may also be used in the fourth embodiment. In an embodiment, switches are formed in the stoppers 408a and 408b respectively. These switches are switched by the touching of the stoppers 408a and 408b and the ring 409. In another embodiment, the switch is only formed in one of the two stoppers 408a and 408b. Moreover, in another embodiment, switch is formed in the ring 409.

It is noticed that two rings and two stoppers used in the foregoing embodiments limit the extendable distances of the earphones. However, in another embodiment, based on actual user habits, one ring and one stopper design may also be used in the store structure.

Accordingly, the earphone storage structure comprises a stopper and a fastener. The earphone and the stopper are located on different sides of the fastener. The fastener and the stopper may together determine the extendable distance of the earphone to avoid the earphone's wire wound together.

As is understood by a person skilled in the art, the foregoing descriptions of the preferred embodiments of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. An earphone storage structure, comprising:
a necklace;
two bases formed in the two ends of the said necklace, wherein each of the said bases includes a fastener; and
at least one earphone connected with a wire and at least one stopper formed in the said wire, wherein when an earphone is not used, the said fastener may fasten the said earphone and fix the said earphone on the said base and when the said earphone is used, the said fastener may fasten a corresponding stopper to limit a distance of the said earphone away from the said base.

2. The structure of claim 1, further comprising a connector formed in the said wire to connect with a hand-held device.

3. The structure of claim 2, further comprising at least one switch located in the said base to control the said hand-held device.

4. The structure of claim 2, wherein the said hand-held device is a cell phone.

5. The structure of claim 2, wherein the said hand-held device is a media player.

6. The structure of claim 2, wherein the said hand-held device is a PDA.

7. The structure of claim 1, further comprising a microphone formed in the said wire.

8. The structure of claim 1, wherein the said fastener is a ring and the size of said ring is less than the size of said earphone and the size of said stopper.

9. The structure of claim 1, further comprising at least one switch located in the said base.

10. The structure of claim 1, further comprising at least one switch located in the said stopper.

11. An earphone storage structure, comprising:
at least one earphone connected with a wire;
at least one fastener, wherein the said earphone passes through the said fastener and fastened with the said fastener; and
at least one stopper formed in the said wire, wherein the said stopper and the said fastener together limit a distance of the said earphone away from the said fastener.

12. The structure of claim 11, further comprising a connector formed in the said wire to connect with a hand-held device.

13. The structure of claim 12, further comprising at least one switch located in the said fastener to control the said hand-held device.

14. The structure of claim 12, wherein the said hand-held device is a cell phone.

15. The structure of claim 12, wherein the said hand-held device is a media player.

16. The structure of claim 12, wherein the said hand-held device is a PDA.

17. The structure of claim 11, further comprising a microphone formed in the said wire.

18. The structure of claim 11, wherein the said fastener is a ring and the size of said ring is less than the size of said earphone and the size of said stopper.

19. The structure of claim 11, wherein the said earphones are located in different sides of the said fastener.

20. The structure of claim 11, wherein the said earphones are located in one side of the said fastener.

21. The structure of claim 11, further comprising at least one switch located in the said base.

22. The structure of claim 11, further comprising at least one switch located in the said stopper.
